(19) United States
(12) Patent Application Publication
(10) Pub. No.: US 2002/0069146 A1
(43) Pub. Date: Jun. 6, 2002

(54) Method and system of processing Internet-based referral fees

(75) Inventors: Jau-Hsiung Huang, Hsin-Tien City (TW); Ja-Ling Wu, Taipei City (TW); Wen-Chin Chen, Taipei City (TW); Ming Ouhyoung, Taipei City (TW)

Correspondence Address: FRANK R. OCCHIUTI, Fish & Richardson P.C., 225 Franklin Street, Boston, MA, 02110-2804, US

(73) Assignee: Cyberlink Corporation, a Taiwan corporation

(21) Appl. No.: 10/051,502

(22) Filed: Jan. 18, 2002

Related U.S. Application Data
(62) Division of application No. 09/506,145, filed on Feb. 17, 2000.

(30) Foreign Application Priority Data
Sep. 14, 1999 (TW) 88115800

(51) Int. Cl. G06F 17/60

(52) U.S. Cl. 705/34; 705/26

(57) ABSTRACT

A method and system of processing referral fees for accessing to a server computer via media player modules. First, a media player module provided by an organization contains a default web page previously defined by the organization. This default web page further contains at least one dynamic links to other web servers that provide relevant products. When one of the dynamic links is chosen, an access command containing a string data representative of the organization is issued to setup the network connection. The linked web server can pay the referral fees to the organization determined by the string if the introduced users complete some transactions.

### BACKGROUND OF THE INVENTION

1. Field of the Invention

The present invention is related to an Internet electronic-commercial technology, more specifically, to a method and system for processing Internet-based referral fees, which are return fees paid for introducing a user to visit a specific web site or server computer through a DVD or Digital TV (DTV) player module, and the DVD or DTV player module therein.

Description of the Prior Art

Electronic commercial is one of the most popular technology fields in the Internet. A variety of electronic business models have been developed as the growth of the Internet. In the Internet, all messages and data are integrated via various dynamic links in the web pages. When users enter a web page provided by a web server, they can access to other web pages in the same web server or pages in other web servers by simply clicking corresponding dynamic links on the current web page. Accordingly, the users can sequentially ferret out the messages or data for which they are searching. FIG. 1 (Prior Art) illustrates an example of Internet browsing. As shown in FIG. 1, the user connects a computer 10 in the client terminal with the Internet and enters a web page 12 on an entrance web server or specific web server. After the user, for example, requests for information about books and locates a dynamic link 14 on the web page 12 that is relevant to books and marked by BOOK.COM, he or she can simply click the dynamic link 14 to send a corresponding access command 30 for dynamically linking with the web server directed by the dynamic link 14. Generally speaking, the access command 30 is an HTTP (HyperText Transmission Protocol) command, but also can be other transmission protocols, such as FTP (File Transfer Protocol). The linked web server (BOOK.COM) can send the data of its homepage 20 back to the computer 10. Therefore, the user can view the information carried by the homepage 20 on the computer 10 or further link to other web pages.

Dynamic linking in the Internet has brought about the idea of the referral fee for the electronic commercial activities. The referral fee is a fee that a first company pays to a second company for introducing Internet users to visit the web server of the first company, usually by dynamic links, according to the agreement previously made by two companies. In general, the linking referral fee can be determined by the number of dynamic link click throughs to the web server of the first company, or by the business activities performed by the Internet user in the web server of the first company. FIG. 2 (Prior Art) demonstrates the procedure of processing referral fees, in which the actions performed by the user are omitted for clarity. In FIG. 2, a web server 1 corresponding to the second company provides a web page containing a dynamic link 32 linking to a web server 2 corresponding to the first company. In addition, the command of the dynamic link 32 contains information for identifying the web server 1 by the linked web server 2, such as specific symbols or a string. Accordingly, the web server 2 can record the number of business transactions or the sales amount made by the users introduced by the web server 1 during browsing the web server 2 within a predefined period (such as one month). Thus, the company corresponding to the web server 2 can calculate and pay the referral fee to the company corresponding to the web server 1 according to the transaction record.

According to the above description, the conventional architecture for processing referral fees is based on the links between different web servers, which may not meet the practical requirements of all products. For instance, video or audio products, such as DVDs or VCDs, are an example. From the consumer's view, they must find out the information about the desired films on the Internet by themselves. In fact, it is common that the users are required to perform several steps to reach the web sites providing desired DVD or VCD products. On the other hand, from the view of the vendors providing DVD or DTV player modules, the users do not always search for these products on their web sites. Therefore, these vendors may lose the chances to earn the referral fees.

### SUMMARY OF THE INVENTION

Therefore, the object of the present invention is to provide a method and system of processing referral fees of Internet links via DVD or DTV player modules, which can facilitate the search for the web site providing various video products for users and increase the incomes of the vendors by additional Internet linking referral fees.

The present invention achieves the above-indicated objects by providing a method of processing a referral fee for accessing to a server computer. First, a media player module provided by an organization is activated on a client terminal. This organization is the vendor of the media (for example, DVD or DTV) player module, which can be implemented by a software program or a hardware device. In addition, the media player module includes a default web page previously defined by the vendor. This default web page further contains at least one dynamic link to other web servers that provide relevant products. When a user chooses one of the dynamic links to setup the network access to the corresponding server computer, the media player module then issues an access command containing a string data representative of the organization. The user browses web pages on the linked web server and transacts business with the target company, if necessary. During this period, the linked web server can store a transaction record pertaining to the access command for registering all transaction activities of the user. Therefore, the linked web server can calculate the referral fee paid to the organization determined by the string data according to the transaction record. It is noted that the media player module should create an image display region for displaying the default web page, for example, on a TV set or a computer monitor. In addition, the transaction record can be the number of transactions or the sales amount of transactions during browsing the web pages on the server computer.

In addition, the present invention also provides a system of processing a referral fee for accessing to a network location. The system includes a client terminal having a media player module provided by an organization, a server computer representative of the network location and a network for connecting the client terminal and the server computer. The media player module has a default web page that contains a dynamic link to the network location. When the user clicks the dynamic link, the media player module can setup the network access to the network location by issuing an access command containing a string data representative of the organization. The server computer stores a transaction record pertaining to the access command for registering all business transactions of the user and calculates the referral fee for the organization determined by the string data according to the transaction record.

In addition, the present invention also provides a media player module provided by an organization, which has a default web page for providing a dynamic link to access to a server computer. An access command together with a string data representative of the organization are sent to the server computer while the dynamic link is chosen. Therefore, the server computer can identify the organization as a target of paying the referral fee according to the string data.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) illustrates an example of Internet browsing;

FIG. 2 (Prior Art) demonstrates the conventional procedure of processing referral fees, in which the actions performed by the user are omitted;

FIG. 3 is a schematic diagram for showing the procedure of processing referral fees according to the embodiment of the present invention; and

FIG. 4 is a flowchart of the procedure of processing referral fees according to the embodiment of the present invention.

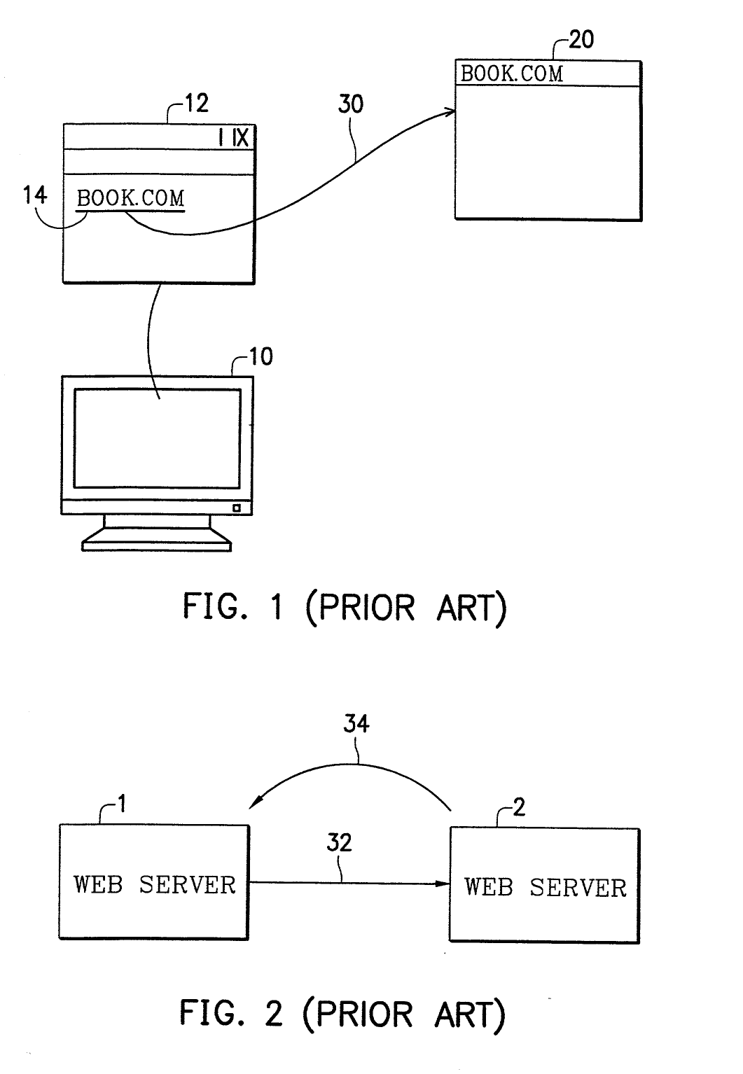

### DETAILED DESCRIPTION OF THE INVENTION

The method of processing referral fees of Internet links disclosed in the present invention is achieved by a DVD or DTV player modules, which are distributed by a specific organization or vendor. Generally speaking, users deal with video data, such as DVD or DTV, by using corresponding DVD or DTV player modules. Accordingly, the present invention adopts the relationship to incorporate the media player modules into the system of Internet-based referral fees. Under such circumstances, users can effortlessly find out the information about DVD or DTV relevant products. In addition, the vendors of the DVD or DTV player modules can acquire additional incomes from the referral fees. For the web sites selling the DVD or DTV products, the visited count and the business volume can be increased. All the participants involved in the transactions can acquire a great benefit.

Although the DVD (or DTV) player module providing such a function is implemented by a software program running on the client computer in this embodiment, it also can be implemented by a hardware device. In the following description, the vendor providing DVD (or DTV) player program is called the source organization and the web server ready for linking is called the target web site.

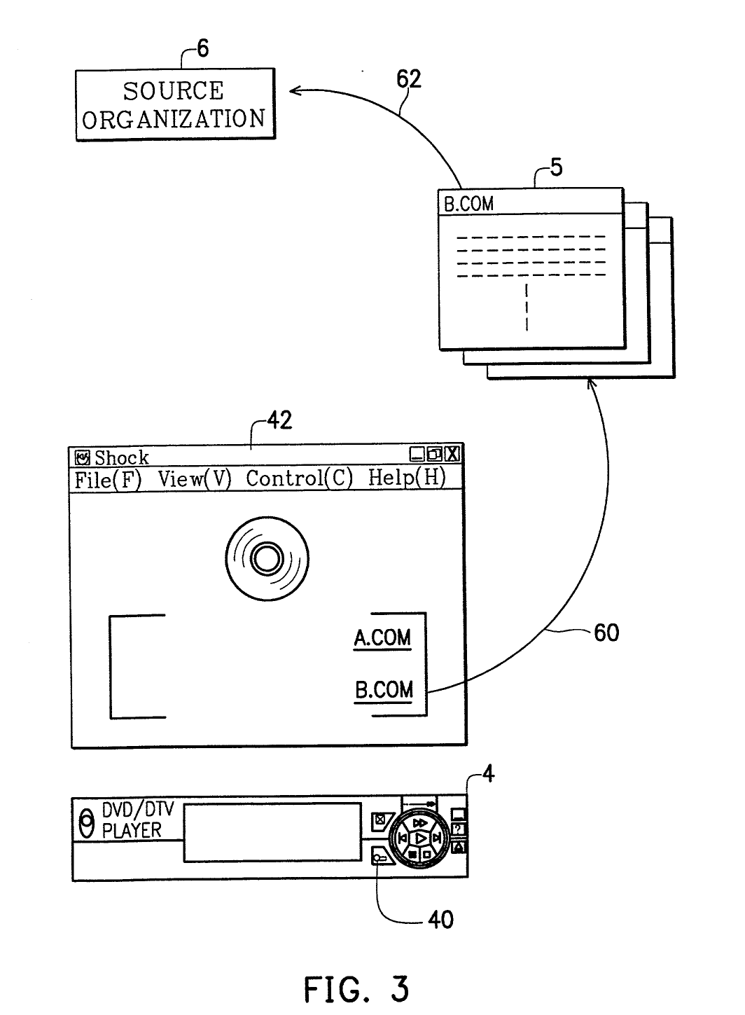

FIG. 3 is a schematic diagram for showing the procedure of processing referral fees in this embodiment. As shown in FIG. 3, reference 4 represents the DVD/DTV player program for playing video data. On the user interface of the DVD/DTV player program 4 there is a default web page key 40 for activating a default web page 42. When the user executes the DVD/DTV player program 4 provided by the source organization 6 in the client computer and clicks the default web page key 40, the default web page 42 is shown on a computer monitor, as depicted in FIG. 3. The default web page 42 can be embedded in the DVD/DTV player program 4 or a specific web page accessed by dynamic links.

The contents of the default web page 42 primarily to provide the user with the information relevant to the sale of video products. In addition, as shown in FIG. 3, there are two dynamic links, denoted by A.COM and B.COM, respectively, on the default web page 42. The dynamic link denoted by B.COM is linked to the target web site 5. When the user chooses the dynamic link denoted by B.COM, the DVD/DTV player program 4 (or the default web page 42) can issues an access command 60 for connecting with the target web site 5. In addition, the access command 60 contains a string for identifying the source organization 6, which is sent together to the target web site 5.

When receiving the access command 60 and the identifying string therein, the target web site 5 can recognize the source organization 6 which produces the DVD/DTV player program introducing the current access according to the identifying string. Accordingly, the target web server 5 can calculate the linking referral fees pertaining to the source organization 5 by the agreement. previously made. Two calculation methods of the referral fees can be applied in this embodiment. The first one is to calculate the referral fees based on the number of the completed transactions and the second one is by the sales amount of the transactions made by the introduced users. It is noted that the calculation bases of the referral fees should be previously negotiated and decided by both sides. Finally, the target web site 5, according to the calculated referral fees during a specific period (such as one month), pays the referral fee 62 to the target organization 6.

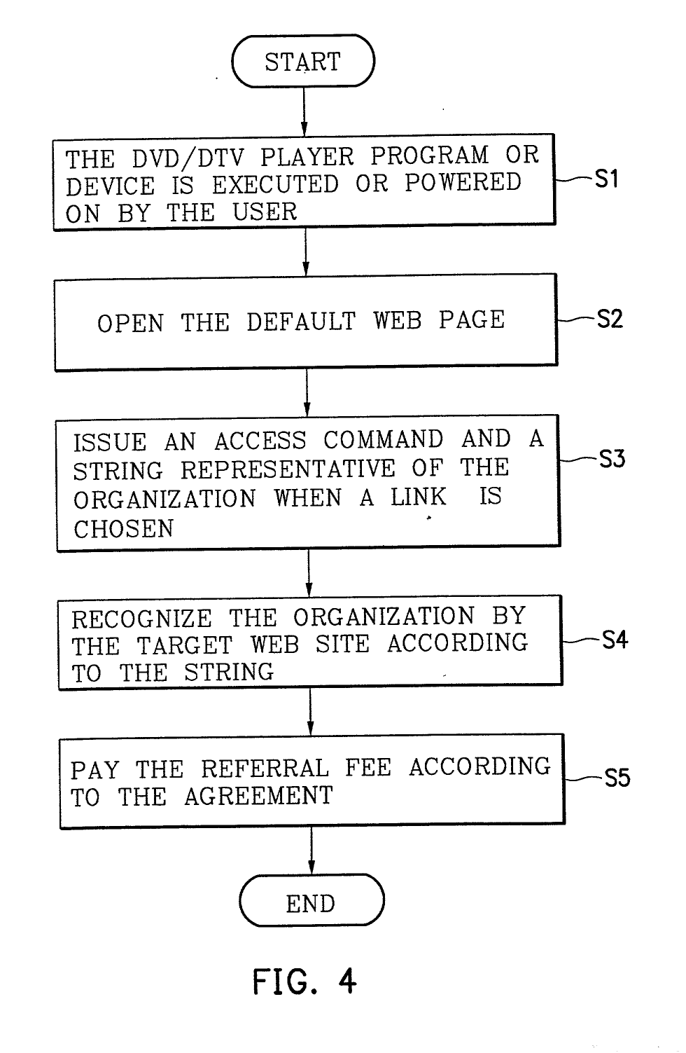

FIG. 4 is a flowchart of the procedure of processing referral fees in this embodiment. First, the user executes the DVD/DTV player program or powers on the DVD/DTV player device manufactured by the source target on a client computer (S1). When requiring relevant product information, the user can click or press a specific key on the user interface of the DVD/DTV player program or device to open the default web page (S2). When the user chooses a dynamic link on the default web page, the DVD/DTV player program or device then issues the access command appended by an identifying string representing the source organization to access to the target web site (S3). The appended identifying string is transmitted to the target web site via the Internet. When receiving the identifying string, the target web site 5 can recognize the source organization 6 which produces the DVD/DTV player program or device that introduces the current access (S4). Accordingly, the target web site 5 pays the corresponding referral fee to the target organization 6 if the introduced users complete a business transaction (S5).

The advantages of the method of processing referral fees via DVD/DTV player module are summarized as follows:

1. Since users usually employ DVD/DTV player programs or devices to play a variety of video data, incorporating the information of various video products into these programs or devices makes it convenient for the users to search for and buy related video products.

2. For the vendors of DVD/DTV player modules, appending the extra browsing function to the DVD/DTV player modules does not only upgrade the performance of these programs or devices, but also can acquire additional incomes of the referral fees.

3. For the web sites selling various video products, the visitor count is increased since the users can readily locate these web sites, thereby enlarging the sales amount.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements

What is claimed is:

1. A method of processing a referral fee for accessing to a server computer, comprising the steps of:
activating a media player module provided by an organization on a client terminal;
opening a default web page defined in the media player module on the client terminal, the default web page having a dynamic link to access to the server computer;
issuing an access command containing a string data representative of the organization when the dynamic link is chosen;
storing a transaction record pertaining to the access command for registering business transactions performed on the server computer; and
calculating the referral fee paid to the organization determined by the string data according to the transaction record.

2. The method as recited in claim 1, wherein the media player module is a software program that is executed on a computer of the client terminal.

3. The method as recited in claim 1, wherein the media player module is a hardware device.

4. The method as recited in claim 1, wherein the media player module is a DVD player.

5. The method as recited in claim 1, wherein the media player module is a Digital TV player.

6. The method as recited in claim 1, wherein the media player module creates an image display region for displaying the default web page.

7. The method as recited in claim 1, wherein the transaction record is the number of transactions performed on the server computer pertaining to the access command.

8. The method as recited in claim 1, wherein the transaction record is the sales amount of transactions performed on the server computer pertaining to the access command.

9. The system of processing a referral fee for accessing to a network location, comprising:
a client terminal having a media player module provided by an organization, the media player module having a default web page that contains a dynamic link to the network location and issuing an access command containing a string data representative of the organization to access to the network location when the dynamic link is chosen;
a server computer representative of the network location, for storing a transaction record pertaining to the access command for registering business transactions performed on the server computer and calculating the referral fee paid to the organization determined by the string data according to the transaction record; and
a network for connecting the client terminal and the server computer.

10. The system as recited in claim 9, wherein the media player module is a software program that is executed on a computer of the client terminal.

11. The system as recited in claim 9, wherein the media player module is a hardware device.

12. The system as recited in claim 9, wherein the media player module is a DVD player.

13. The system as recited in claim 9, wherein the media player module is a Digital TV player.

14. The system as recited in claim 9, wherein the transaction record is the number of transactions performed on the server computer pertaining to the access command.

15. The system as recited in claim 9, wherein the transaction record is the sales amount of transactions performed on the server computer pertaining to the access command.

16. A media player module provided by an organization, comprising:
a default web page for providing a dynamic link to access to a server computer, an access command together with a string data representative of the organization being sent to the server computer while the dynamic link is chosen, the server computer identifying the organization as a target of paying the referral fee according to the string data.

17. The media player module as recited in claim 16, wherein the media player module is implemented by a software program.

18. The media player module as recited in claim 16, wherein the media player module is implemented by a hardware device.

19. The media player module as recited in claim 16, wherein the media player module is a DVD player.

20. The media player module as recited in claim 16, wherein the media player module is a Digital TV player.
